(19) United States
(12) Patent Application Publication
(10) Pub. No.: US 2005/0283590 A1
(43) Pub. Date: Dec. 22, 2005

(54) Reducing false error detection in a microprocessor by tracking dynamically dead instructions

(76) Inventors: Christopher T. Weaver, Marlboro, MA (US); Shubhendu S. Mukherjee, Framingham, MA (US); Joel S. Emer, Acton, MA (US); Steven K. Reinhardt, Ann Arbor, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/872,109

(22) Filed: Jun. 17, 2004

(51) Int. Cl. G06F 9/40

(52) U.S. Cl. 712/218

(57) ABSTRACT

A technique to reduce false error detection in microprocessors by tracking dynamically dead instructions. When an instruction commits, it is then stored in a PET buffer. A processor may now declare a machine check error when the instruction is being removed from the PET buffer rather than at the commit point. The processor can scan the PET buffer to determine if the instruction is a dynamically dead instruction. This further enables the processor to reduce false positives.

### RELATED APPLICATIONS

This application relates to the following commonly assigned co-pending applications filed on even date herewith and entitled: “Method And Apparatus For Reducing False Error Detection In A Microprocessor,” Ser. No. ______, filed Jun. 17, 2004; and “Reducing False Error Detection In A Microprocessor By Tracking Instructions Neutral to Errors,” Ser. No. ______, filed Jun. 17, 2004.

### BACKGROUND INFORMATION

Transient faults due to neutron and alpha particle strikes are emerging as a significant obstacle to increasing processor transistor counts in future process technologies. Although fault rates of individual transistors may not rise significantly, incorporating more transistors into a device makes that device more likely to encounter a fault. As a result, it is expected that maintaining processor error rates at acceptable levels will require increasing design efforts.

Single bit upsets from transient faults have emerged as one of the key challenges in microprocessor design today. These faults arise from energetic particles, such as neutrons from cosmic rays and alpha particles from packaging materials. Transistor source and diffusion nodes can collect these charges. A sufficient amount of accumulated charge may invert the state of a logic device, such as an SRAM cell, a latch, or a gate, thereby introducing a logical fault into the circuit's operation. Because this type of fault does not reflect a permanent failure of the device, it is known as soft or transient error.

Soft errors are an increasing burden for microprocessor designers as the number of on-chip transistors continues to grow exponentially. The raw error rate per latch or SRAM bit is projected to remain roughly constant or decrease slightly for the next several technology generations. Thus, unless additional error protection mechanisms or usage of more robust technology (such as fully-depleted SOI), a microprocessor's error rate may grow in direct proportion to the number of devices added to a processor in each succeeding generation.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the inventions.

FIG. 1 is a block diagram of possible outcomes of a faulty bit in a microprocessor.

FIG. 2 is a block diagram illustrating one embodiment of the present invention having an error tracking buffer to store instructions after they commit.

FIG. 3 is a block diagram illustrating eviction of the instructions from the error tacking buffer of FIG. 2.

FIG. 4 is block diagram illustrating another embodiment of the present invention during a store and load request.

FIG. 5 is a flow diagram illustrating operations according to one embodiment of the present invention.

FIG. 6 is a block diagram illustrating an exemplary computer system which implements the present invention to detect soft errors.

### DETAILED DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

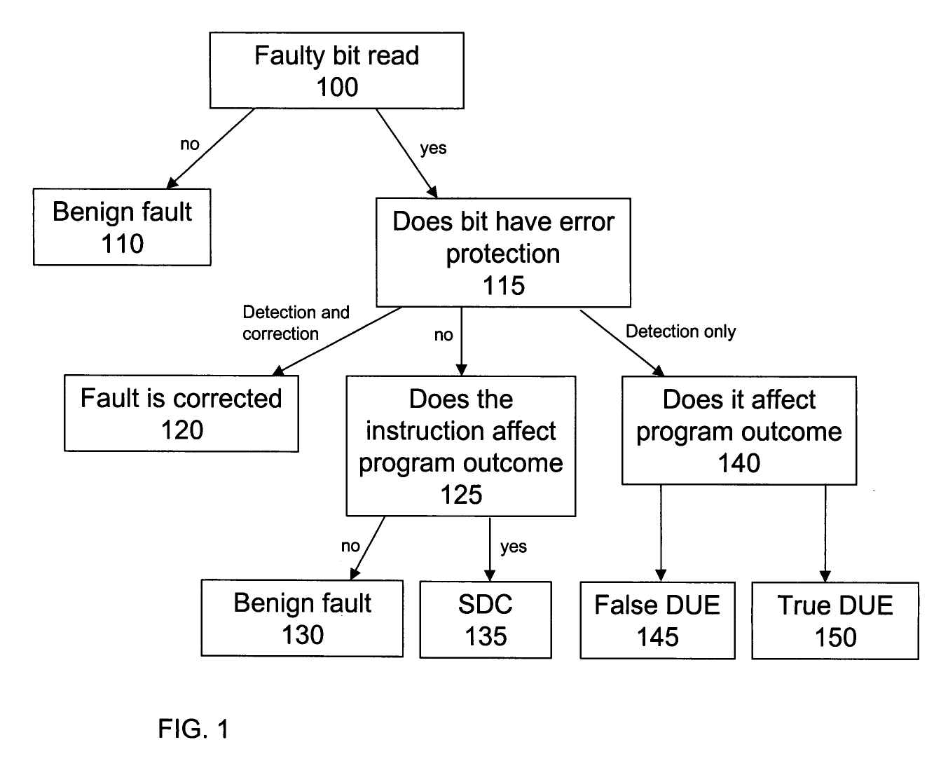

FIG. 1 illustrates possible outcomes of a single bit fault in a microprocessor. Initially, the microprocessor determines if a faulty bit was read 100. If a faulty bit was not read 110, then it is considered a benign fault and thus no error. If a faulty bit was read, the processor next determines if the bit has error protection 115. There are at least three possible outcomes to when a faulty bit is read. First, if the error protection was detected for the bit and corrected then the fault is considered corrected 120.

Secondly, if the bit does not have error protection, then the processor determines if the instruction would affect the outcome of the program 125. If the instruction does not affect the outcome of the program then the faulty bit is considered a benign fault 130. Faults 110, 120 and 130 all indicate non-error conditions because the fault had no effect or was detected and corrected.

If the instruction does affect the outcome of the program then it is considered a silent data corruption (SDC) 135. SDC 135 is the most insidious form of error, where a fault induces the system to generate erroneous outputs. To avoid SDC 135, designers may employ basic error detection mechanisms such as parity.

The third possible outcome to when a bit has error protection applies to this situation where the error is detected 140. With the ability to detect a fault but not correct it, the system avoids generating invalid outputs, but cannot recover when an error occurs. Thus, simple error detection does not reduce the error rate, but does provide fail-stop behavior and thereby reduces any data corruption. These types of errors are known as detected unrecoverable errors (DUE).

DUE events are further subdivided according to whether the detected errors would affect the final outcome of the execution. Benign detected errors are known as false DUE events 145 and others are known as true DUE events 150. In a microprocessor, false DUE events could arise from strikes on wrong-path instructions, falsely predicated instructions, and on correct-path instructions that do not affect the final program state, including no-ops, prefetches, and dynamically dead instructions.

To track false DUE events, the microprocessor attaches a bit known as a pi bit, for Possibly Incorrect, to every instruction and potentially to various hardware structures (discussed in detail in related application). When an error is detected, the hardware will set the pi bit of the affected instruction instead of signaling the error. Later, by examining the pi bit and identifying the nature of the instruction, the hardware can decide if indeed a visible error has occurred.

Distinguishing false errors from true errors is complicated. The processor may not have enough information to make this distinction at the point it detects the error. For instance, when the instruction queue detects an error on an instruction, it may not be able to tell whether the instruction was a wrong path instruction or not. Consequently, the processor needs to propagate the error information down the pipeline and raise the error when it has enough information to make this distinction.

To propagate the error information between different parts of the microprocessor hardware, the system makes use of the pi bit. The pi bit is logically associated with each instruction as it flows down the pipeline from decode to retirement.

The pi bit mechanism helps avoid false positive matches from the fault detection mechanism, such as parity. Specifically, for an instruction, when an instruction is decoded 205, a pi bit is attached to the instruction and initialized to zero to denote that the instruction has not encountered any error. As the instruction flows through the pipeline 200, it will be transformed multiple times to adapt to the machine and written to and read from many different storage structures. If the storage structure 210 has some form of fault detection, such as parity, and the instruction accumulates a single bit upset, the parity error will be flagged. Usually, this would raise a machine check exception, typically causing the machine to crash. Here, instead of the machine crashing, the processor posts this error in the pi bit by changing its value to one.

At a commit stage 215 in the pipeline 200, the commit hardware has enough information to determine if the instruction was a wrong path instruction, falsely predicated instruction, or a NOP instruction. In these cases, the processor will not raise a machine check exception and will let the machine proceed normally. In other cases, however, it may have been a true error and must raise a machine check exception.

The pi bit (discussed in detail in related application) is good at propagating (potential) error information between hardware structures, thereby delaying the machine check exception till the machine must absolutely declare the error. However, the pi bit by itself cannot tell if a particular structure encountered a fault and whether the fault will eventually be visible to the user. The pi bit mechanism relies on error detecting techniques, such as parity, to detect single bit upsets. The anti-pi bit (discussed in detail in related application) and a Post Commit Error Tracking (PET) buffer are two techniques to help the pi bit mechanism to identify certain cases in which a fault will not actually manifest itself as a user-visible error.

There are many instances in a microprocessor where a fault on certain instruction types will not result in an error. The anti-pi bit tracks instructions and hardware activities that are neutral to errors. When combined with the pi bit, the anti-pi bit helps further reduce the rate of false error detection. For example, a strike on the non-opcode bits of a NOP instruction will not usually result in any error visible to a user. Similarly, a strike on a prefetch instruction or branch predict hint instruction, which typically enhances performances of a microprocessor, but does not affect its correctness, will also not cause an error. Such instructions are neutral to errors. The anti-pi bit tracks such instructions through the pipeline and reduces the number of false positives.

Even in the stream of committed instructions that are not performance-enhancing instructions or NOPs, there are numerous instances in which a fault will not manifest itself as a user-visible error. These arise from dynamically dead instructions, whose destination register is rewritten before any intervening use of this register.

This application describes another technique to further reduce such false positives. During the execution of a program, there are many instances in which the result or destination register of an instruction will never be used by any subsequent instruction. Usually, another instruction will overwrite the register before any intervening instruction can read it. The first instruction in this sequence is known as a dynamically dead instruction (DDI). Faults on most bits, except the destination specifier bits, of a dynamically dead instruction may not result in a user-visible error.

Unlike in wrong-path instructions, when an instruction commits, the system does not know whether the instruction is dynamically dead or not. Whether an instruction that is about to commit is dynamically dead or not depends on the future use of its destination register, which is not available at the commit point. Thus, even if an instruction is dynamically dead, the system may have to raise a machine check exception on this instruction, if its pi bit is set.

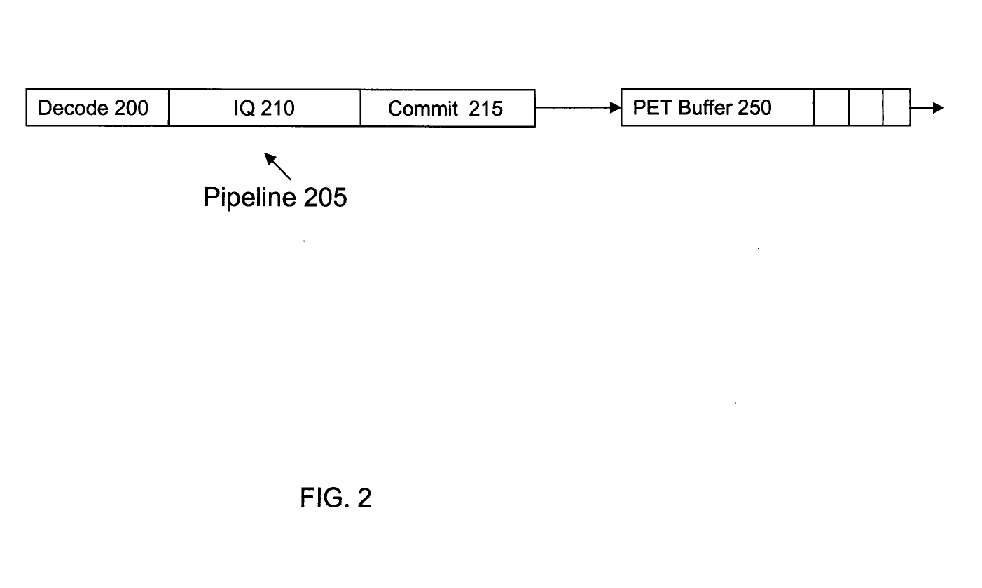

FIG. 2 illustrates one embodiment of a PET buffer which allows tracking of DDI. A PET buffer allows the hardware to reduce the number of falsely declared errors on dynamically dead instructions. The instructions are stored, in a PET buffer 250, even after they commit 215. Commitment may be the point at which the instruction is retired to architectural state. The PET buffer 250 may receive instructions after they are retired from a retirement stage of the pipeline. The pipeline may be an in-order or out-of-order pipeline. For example, the PET buffer 250 may receive instructions from a re-order buffer or other ordering structure in an out-of-order pipeline, or may receive instructions from an in-order retirement unit in an in-order machine.

The PET buffer 250 may be for example, a FIFO buffer. With the PET buffer 250, the processor may now declare the error not at the commit point 215 of an instruction. Rather, the processor raises a machine check only when an instruction must be removed from the PET buffer 250. When an instruction is about to be removed from the PET buffer 250, the hardware can scan the buffer to find information on its future use. If the PET buffer 250 helps determine that the instruction to be removed from the PET buffer 250 is a dynamically dead instruction, then the processor does not have to raise an error, even if its pi bit is set.

However, when an instruction commits 215, the system does not have any information on the future use of this instruction and, therefore, cannot determine if the instruction is dead. Thus, in the absence of the PET buffer, if the pi bit of the instruction is set, a machine check exception would be raised by the commit point 215 of the instruction, even if the instruction would have later proven to be dynamically dead.

When an instruction commits 215, the instruction is entered in the PET buffer 250. If there is space in the PET buffer 250, the insertion of the instruction works without a problem. If there is no space in the PET buffer 250, meaning the buffer is full, the processor must first evict an older instruction from the PET buffer 250 before inserting the instruction.

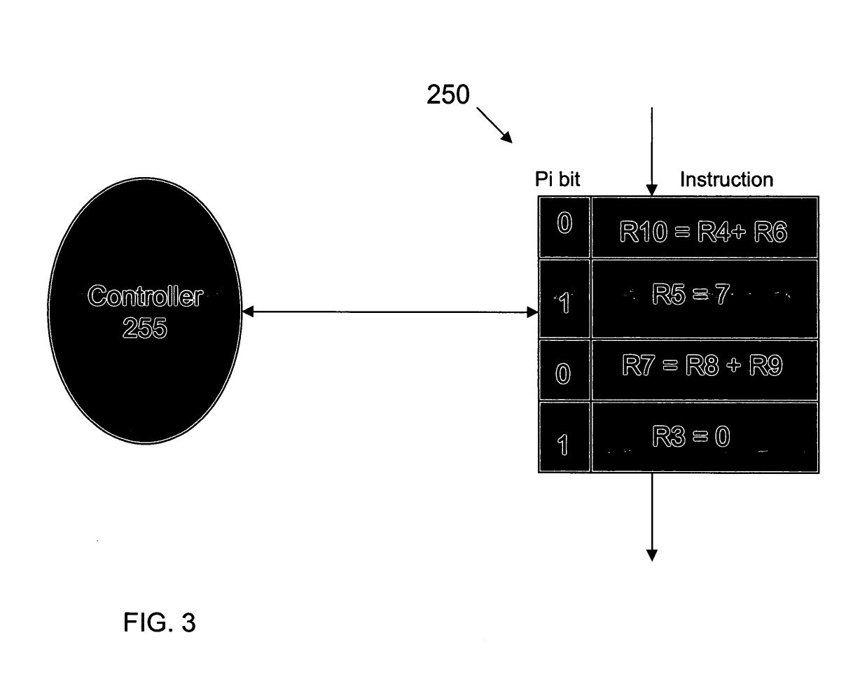

FIG. 3 illustrates eviction of an instruction from the PET buffer 250. To evict an instruction from the PET buffer 250, the system checks if the pi bit is set. If so, then an error may need to be raised on the instruction, unless the instruction is determined to be a dynamically dead instruction. To determine if the instruction is dynamically dead, the PET buffer 250 is examined by a controller 255 to see if any other instruction will overwrite its content (i.e., overwrite the result of this instruction) before an intervening read. The controller 255 determines how the data stored in the PET buffer 250 is to be interpreted.

If an instruction currently in the PET buffer may overwrite the result of the to-be-evicted instruction before an intervening read, then the instruction is declared to be dynamically dead because the result of the instruction is never used. Therefore, the error may be suppressed. Otherwise, a machine check exception is raised to process the error.

For example, assuming the PET buffer 250 is full. If the instruction to be stored in the buffer 250 is R3=R1+R2. The controller 255 may interpret the information in the buffer 250 to determine if this instruction (R3=R1+R2) may overwrite the result of the to-be-evicted instruction before an intervening read. In this case, the buffer has an entry where R3=0. This entry will be evicted prior to a read and thus may be declared to be dynamically dead by the controller 255 because the result of this instruction will not be used. Therefore, this instruction (R3=0) is evicted and the new instruction R3=R1+R2 is now stored in the PET buffer 250.

There are at least three sources of dynamically dead instructions: through registers, through memory, and through returns. With respect to dynamically dead instructions coming from a register file, at the commit point 215 of an instruction, the processor may not know if the source operands may have a potential error. In this case, a table indexed by the register number maybe maintained. This table indicates if the last writer of the register had its pi bit set. Then, an instruction that is about to commit can look up the table to determine if it needs to examine entries in the PET buffer. Thus, in the common case of no errors, a committing instruction need not examine the PET buffer.

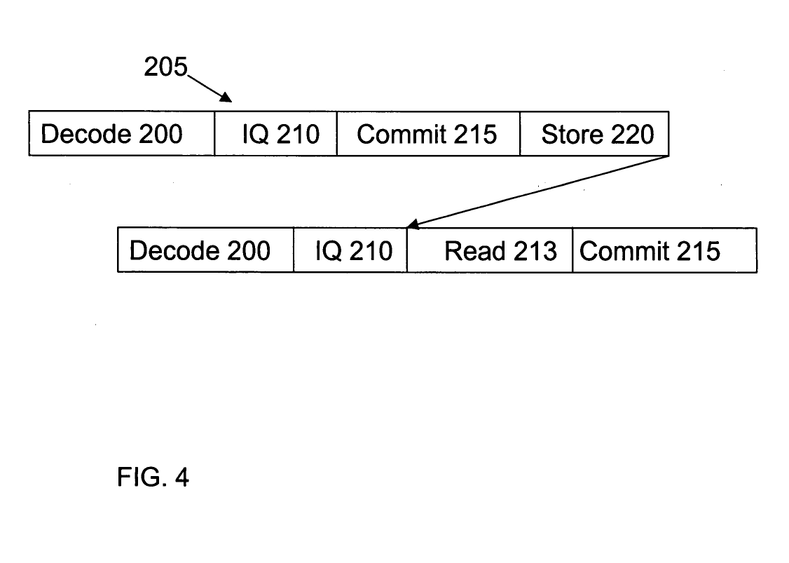

FIG. 4 illustrates one embodiment to avoid data corruption in memory. In a pipeline 205, once an instruction is decoded 200 a pi bit is attached to the instruction and initialized to zero to denote that the instruction has not encountered any error. As the instruction flows through the pipeline 205 it will be transformed multiple times to adapt to the machine and written to and read from many different storage structures. If the storage structure 210 has some form of fault detection, such as parity, and the instruction accumulates a single bit upset, the parity error will be flagged. At the commit stage 215 in the pipeline 205, the commit hardware has enough information to determine if the instruction encountered a soft error. Next, the instruction is stored 220.

To avoid data corruption in memory, whenever a store instruction leaves a store buffer 220, an error is declared if its pi bit is set. However, if the pi bit is not set, the store instruction commits its result. When a load request comes in, the instruction is read from memory 213. Letting the store instruction's data propagate to memory will not cause a data corruption. This embodiment allows for a fail-stop model with respect to store instructions because the processor is stopped as soon as it produces incorrect data via a store instruction.

Alternatively, if a fail-stop model with respect to every instruction is needed (i.e., stop if an instruction produces incorrect data), then the store instruction's data can never propagate to the memory system until all prior instructions have been certified as error-free. In order to obtain this result, the size of the PET buffer may need to be limited. Furthermore, if the caches also contain the pi bit, then the store data can go to the caches. Then, only when a write-back from the cache to the main memory of a block with the pi bit set, does the processor raise a machine check exception.

Returns are yet another source of DDI. In an architecture that has a register window, on a return from a procedure, all local registers produced by the specific procedure become dead after the return.

Advantageously, the PET buffer not only reduces the DUE (detected unrecoverable error) rate, but also in some embodiments allows the use of a fail-stop model, either with respect to store instructions or with respect to every instruction, depending on the implementer's choice.

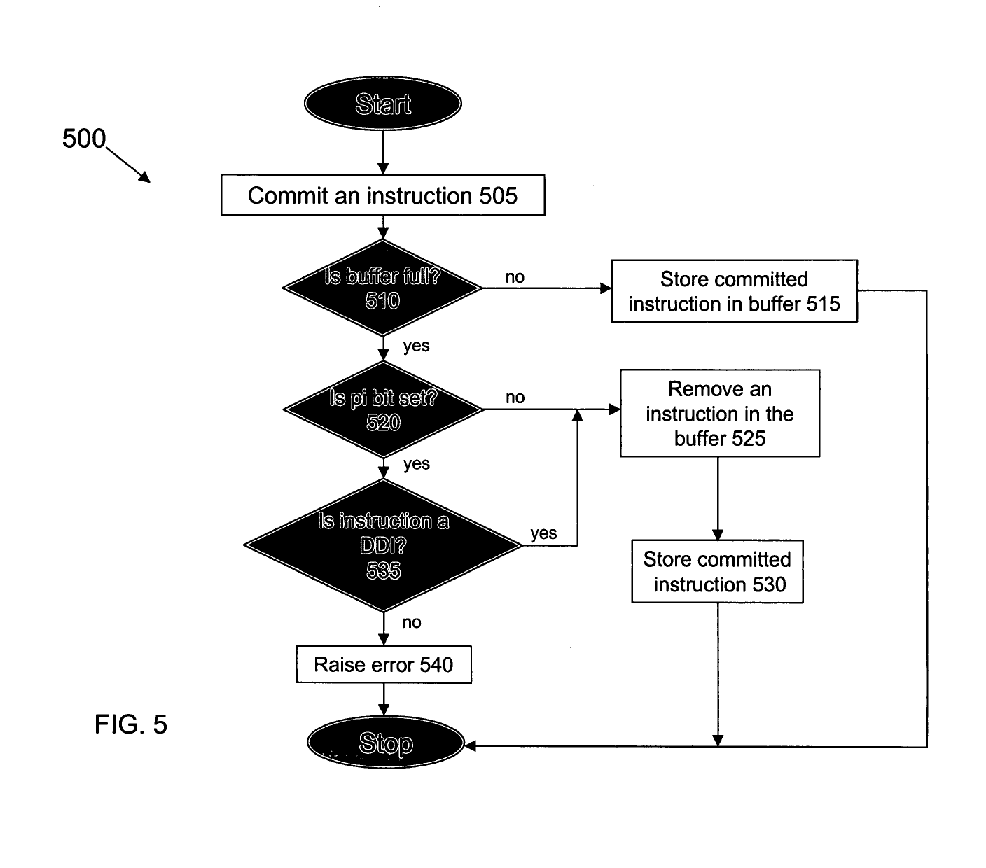

FIG. 5 is a flow diagram illustrating one embodiment of a method of detecting soft errors. In this particular embodiment, flowchart 500 illustrates a case where a processor determines if an error occurs on an instruction that is dynamically dead. Initially, when an instruction commits 505, the committed instruction is to be entered in the PET buffer. However, first the processor needs to determine if the PET buffer is full 510. If the PET buffer is not full, the committed instruction is stored in the buffer 515, otherwise, the processor must first evict an older instruction from the PET buffer before inserting the committed instruction.

To evict an instruction from the PET buffer, the processor may first checks if the pi bit is set 520. If the instruction's pi bit is not set, meaning an error may have not been raised on the instruction, then the instruction may be removed from the buffer 525 and the committed instruction may now be stored in the PET buffer 530. However, if the instruction to be removed has its pi bit set, then the processor may determine if the instruction is a dynamically dead instruction 535. If the instruction to be removed is determined to be a dynamically dead instruction, then that instruction may be removed from the buffer 525 and the committed instruction may now be stored in the PET buffer 530. Otherwise an error may be raised 540.

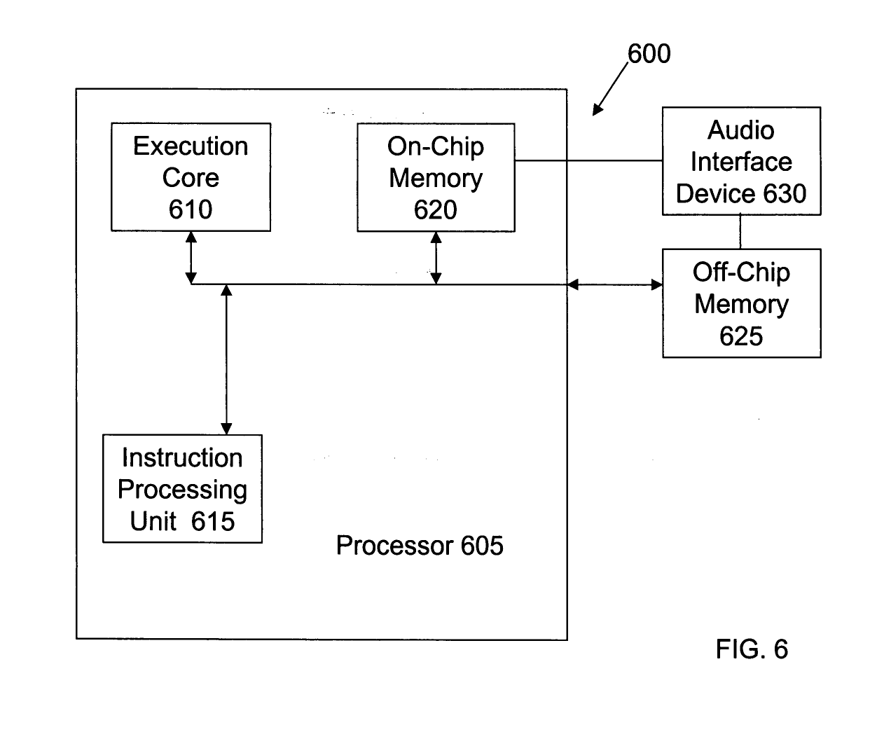

FIG. 6 illustrates one typical system implementation for the detecting soft errors. A computer 600 is shown in which a processor 605 functions as a sole or one of a plurality of processors comprising the central processing unit (CPU) or units of the computer 600. Typically, the processor 605 is embodied in a single integrated circuit chip. The processor 605 may include an execution (processing) core 610, which has one or more execution units. A section of the processor 605 is dedicated to include an instruction processing apparatus 615. The instruction processing apparatus 615 is shown coupled to the core 610.

The invention is practiced according to the description above to execute an instruction in the core 610. The memory can be located on-chip (as shown by on-chip memory 620) or off-chip (as shown by off-chip memory 625). Typically, the on-chip memory can be a cache memory or part of the main memory (RAM). The off-chip memory is typically comprised of main memory (as well as off-chip cache, if present) and other memory devices, such as a disk storage medium. However, it is to be noted, that the invention can be configured in other ways to process the instructions for execution by the core 610.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

1. A method comprising:
committing an instruction;
storing the instruction in a buffer;
determining if the instruction is dynamically dead;
removing the instruction from the buffer; and
raising an error if instruction is not dynamically dead.

2. The method of claim 1 wherein removing the instruction from the buffer further comprises:
checking state of a bit of the instruction; and
examining other instructions if the bit is set.

3. The method of claim 2 wherein the examining other instructions further comprises:
determining if the other instructions will overwrite a result of the removed instruction prior to an intervening read; and
raising an error if the result of the instruction is not overwritten.

4. A processor comprising:
a commit module to commit an instruction; and
a buffer coupled to the commit module to store the instruction, wherein the processor raises an error if the instruction is not a dynamically dead instruction in response to a removal of the instruction from the buffer.

5. The processor of claim 4 further comprising a bit associated with the instruction.

6. The processor of claim 5 wherein the processor examines state of the bit.

7. The processor of claim 6 wherein if bit is set, the processor examines other instructions in the buffer.

8. The processor of claim 7 wherein the processor determines if the other instructions will overwrite a result of the removed instruction prior to an intervening read.

9. The processor of claim 8 wherein the processor raises an error if the result of the instruction will not be overwritten.

10. The processor of claim 5 wherein the bit is a pi bit.

11. The processor of claim 6 wherein the bit is set due to a parity error.

12. An apparatus comprising:
a decode module to decode an entry;
a bit associated with the entry;
a pipeline coupled to the decode module to propagate the flow of entries through multiple stages;
a commit module coupled to the pipeline to commit the entry; and
a buffer coupled to the commit module to store the entry after being committed.

13. The apparatus of claim 12 wherein the bit is a pi bit.

14. The apparatus of claim 12 wherein the apparatus raises an error if the entry is not a dynamically dead entry.

15. The apparatus of claim 12 further comprising a controller coupled to the buffer to interpret the entries in the buffer.

16. The apparatus of claim 15 wherein the controller checks other entries in the buffer prior to removing the entry from the buffer.

17. The apparatus of claim 16 wherein the controller determines if other entries will overwrite a result from the entry prior to an intervening read.

18. The apparatus of claim 17 wherein an error is raised if the result from the entry will not be overwritten.

19. The apparatus of claim 12 further comprising an instruction queue to process the entry.

20. A system comprising:
an off-chip memory to store an entry prior to fetching; and
processor coupled to the off-chip memory, wherein the processor further comprises:
a decode module to decode an entry;
a bit associated with the entry;
a pipeline coupled to the decode module to propagate the flow of entries through multiple stages;
a commit module coupled to the pipeline to commit an entry; and
a buffer coupled to the commit module to store the entry after being omitted.

21. The system of claim 20 further comprising an audio interface coupled to the off-chip memory.

22. The system of claim 20 further comprising a controller coupled to the buffer to interpret the entries in the buffer.

23. The system of claim 20 wherein the bit is a pi bit.

24. The system of claim 20 wherein the system raises an error if the entry is not a dynamically dead entry.

25. The system of claim 20 further comprising an instruction queue to process the entry.

26. The system of claim 22 wherein the controller checks other entries in the buffer prior to removing the entry from the buffer.

27. The system of claim 26 wherein the controller determines if other entries will overwrite a result from the entry prior to an intervening read.

28. The system of claim 27 wherein an error is raised if the result from the entry will not be overwritten.
